(19) United States
(12) Patent Application Publication
(10) Pub. No.: US 2008/0242803 A1
(43) Pub. Date: Oct. 2, 2008

(54) POLYPROPYLENE DERIVATIVES AND PREPARATION THEREOF

(75) Inventors: Lien Tai CHEN, Taoyuan City (TW); Chi-Wei Hsu, Hsinchu County (TW); Tun-Fun Way, Hsinchu (TW); Jian-Lin Hua, Taichung City (TW)

Correspondence Address: Muncy, Geissler, Olds & Lowe, PLLC, P.O. BOX 1364, FAIRFAX, VA, 22038-1364, US

(73) Assignee: Industrial Technology Research Institute

(21) Appl. No.: 12/135,476

(22) Filed: Jun. 9, 2008

Related U.S. Application Data
(63) Continuation-in-part of application No. 11/907,593, filed on Oct. 15, 2007.

(30) Foreign Application Priority Data
Dec. 28, 2006 (TW) 95149469

(51) Int. Cl. C08F 4/34; C08F 255/02; C08F 265/00

(52) U.S. Cl. 525/265; 525/322; 525/302; 525/242; 525/263

(57) ABSTRACT

A polypropylene derivative is provided. The polypropylene derivative includes a reactive monomer grafted on polypropylene, with a grafting yield exceeding 5%. A method for preparing the polypropylene derivative is also disclosed. The method includes mixing a reactive monomer, polypropylene and a compatibilizer to prepare a polypropylene derivative grafted with the reactive monomer, with a grafting yield exceeding 5%.

This application is a Continuation-In-Part of pending U.S. patent application Ser. No. 11/907,593, filed Oct. 15, 2007, and entitled “polypropylene derivatives and preparation thereof”.

This application claims priority of Taiwan Patent Application No. 95149469, filed Dec. 28, 2006, the entirety of which is incorporated by reference herein.

### BACKGROUND OF THE INVENTION

1. Field of the Invention

The invention relates to a polymer derivative, and in particular to a polypropylene derivative and preparation method thereof.

2. Description of the Related Art

Polypropylene (PP) is widely used in apparel textiles, automobile textiles, leisure products, suitcases, carpets, and ropes, etc. Though with such a wide range of applications, use of polypropylene is still limited by its chemical inertness and difficulty to blend with other polymers for specialty applications. Moreover, one important feature of polypropylene that requires improvement is its coloring. Currently, polypropylene is colored by blending pigments into the polymer, or into the spinning dope, in the case of fiber production. Although deep-color polypropylene materials can thus be obtained, the variety of colors achievable is rather limited in comparison with conventional dying of polyesters and polyamides. The limitation originates from difficulty in precision tuning of colors by the pigment blending process. Furthermore, complete cleaning of the blending machine to avoid batch-to-batch contamination is costly and difficult.

Polyalkenes and their copolymers with maleic anhydride (MAH) or other reactive comonomers grafted thereon have been disclosed. R. A. Zelonka and C. S. Wong (U.S. Pat. No. 4,612,155) disclosed formation of the polyalkene materials with unsaturated reactive monomers grafted thereon by a twin-screw extruder. Steinkamp (U.S. Pat. No. 3,862,265 and U.S. Pat. No. 4,001,172) disclosed modified polyolefins with the MFR up to 1000 dg/min via extrusion reaction; however, they could only achieve an MFR of 71 dg/min for polypropylene. The percent of MAH grafted to PP is as low as 0.53% by weight.

V. Flaris (U.S. Pat. No. 6,228,948) disclosed an MAH grafted polypropylene with a grafting yield of 1.5-3.8% by weight. The grafting reaction was conducted in a high-speed twin-screw extruder. J. L. Pradel (U.S. Pat. No. 7,067,196) disclosed blending of a grafted polypropylene binder with other materials for application in films and packaging materials in 2006. M. G. Botros (U.S. Pat. No. 7,030,188) disclosed an MAH grafted polypropylene-polyethylene copolymer with a grafting yield of 2.17% with addition of Luperox101 as an initiator. The resultant materials are intended for use in thermal plastics and filtration.

In all of the searched literature, the grafting yield of polypropylene derivatives is less than 5%, indicating that a technical barrier for achieving high grafting yield exists. Though polypropylene has been widely used in many applications, modification of polypropylene with additional or enhanced functionalities, will allow it to penetrate even more markets and be used in even more applications. This invention discloses novel polypropylene derivatives, and the manufacturing method thereof, with a functional comonomer grafting yield exceeding 5%.

### SUMMARY OF THE INVENTION

One embodiment of the invention provides polypropylene derivatives comprising a reactive monomer grafted on polypropylene, with a grafting yield exceeding 5%.

Another embodiment of the invention provides a method for preparing polypropylene derivatives comprising mixing a reactive monomer, polypropylene and a compatibilizer to prepare a polypropylene derivative grafted with the reactive monomer, with a grafting yield exceeding 5%.

A detailed description is given in the following embodiments.

### DETAILED DESCRIPTION OF THE INVENTION

The following description is of the best-contemplated mode of carrying out the invention. The following description is made for the purpose of illustrating the general principles of the invention and should not be taken in a limiting sense. The scope of the invention is best determined by reference to the appended claims.

One embodiment of the invention provides polypropylene derivatives comprising a reactive monomer grafted onto polypropylene. The polypropylene derivatives have a grafting yield exceeding 5% or 6%.

The reactive monomer grafted onto the polypropylene may comprise various unsaturated ethylene monomers, for example, methyl(meth)acrylate, benzyl(meth)acrylate, ethyl(meth)acrylate, 2-hydroxyethyl(meth)acrylate, hydroxylpropyl(meth)acrylate, isobutyl(meth)acrylate, methyl acrylate, benzyl acrylate, ethyl acrylate, 2-hydroxyethyl acrylate, hydroxylpropyl acrylate, isobutyl acrylate, styrene, vinyltoluene, methylstyrene, 2,4-dimethylstyrene, vinyl acetate, vinyl propionate, Vinyl pivalate or combinations thereof.

One embodiment of the invention provides a method for preparing polypropylene derivatives comprising mixing a reactive monomer, polypropylene and a compatibilizer to prepare a polypropylene derivative grafted with the reactive monomer, with a grafting yield exceeding 5%.

The polyethylene may comprise grains, powders or a combination thereof. The powdery polyethylene may be formed by smash or pulverization. The fineness of the polyethylene is about 20-160 mesh.

The compatibilizer may comprise polypropylene-containing surfactants or block copolymers or grafted copolymers of the reactive monomer and the polypropylene, for example, polypropylene-co-poly(methyl methacrylate), polypropylene-co-poly(ethyl methacrylate), polypropylene-co-poly(methyl ethacrylate) and polypropylene-co-poly(ethyl ethacrylate), etc. The reactive monomer has an amount of about 5-25 wt % (based on the total weight of the reactant) or 10-15 wt %. The compatibilizer has an amount of about 20-50 wt % or 30-40 wt %.

An initiator is further mixed to trigger the synthetic reaction. The initiator may comprise peroxides such as benzoyl peroxide (BPO) or azo compounds such as 2,2′-Azobisisobutyronitrile (AIBN). The initiator has an amount of about 0.5-5 wt % (based on the total weight of the reactant) or 1-3 wt %.

The polyethylene derivative is prepared in, for example, reaction tanks or various mixers or extruders such as twin-screw mixer, single-screw mixer, single-screw extruder, twin-screw extruder, Banbury mixer or continuous mixer. The reaction temperature may be 170-250° C. or 180-210° C. The reaction time may be 3-15 min or 5-8 min.

During the synthetic reaction, the compatibilizer is added to improve the grafting yield of the polyethylene derivative. The high-reactivity acrylate derivative monomer is grafted onto the polyethylene to prepare a modified polyethylene material with a grafting yield exceeding 6%. The polyethylene derivative is a spinning-level polymer, with a melt index of about 9-35. The polyethylene derivative is directly spun without split due to its large molecular weight. Additionally, the high-grafting-yield polyethylene fiber has superior dyeing, when compared with conventional polyethylene fibers.

### COMPARATIVE EXAMPLE 1

0.5 g polypropylene powder and 0.2 g 2-hydroxy-2-methylproptophemone, used as an initiator, were added to 10 mL methanol. The mixture was stirred to form a uniform slurry. Then 2 mL methyl methacrylate (MMA) monomer was added into the slurry. Grafting reaction between MMA and polypropylene was performed in the solid state after heating with a 100W ultraviolet lamp. The reaction was allowed to proceed for 4 hours. After the reaction was completed, the reaction mixture was filtered. The retained solid was washed with 50 mL acetone and dried repeatedly for three times. White powder of polypropylene-g-polymethyl methacrylate (PP-g-PMMA) was then obtained. The NMR and IR tests indicated that the grafting yield was about 2-4%, as shown in Table 1.

### COMPARATIVE EXAMPLE 2

0.5 g benzoyl peroxide (BPO) and 6 g methyl methacrylate (MMA) were mixed and stirred in a beaker at room temperature until the benzoyl peroxide was completely dissolved. The solution was then slowly dropped into 53.5 g polypropylene powder, and the blend was well stirred. The polypropylene powder was then subjected to a twin-screw extrusion to induce melt reaction. The polypropylene powder was prepared as follows. The polypropylene solid was first smashed by liquid nitrogen, and then pulverized by a pulverizer to prepare the polypropylene powder. Grafting reaction between MMA and polypropylene occurred and PP-g-PMMA was formed. Note that the resultant polymer may have contained PP-g-PMMA and other polymers such as polypropylene or PMMA homopolymer, as a result of the complex melt reactions.

The resultant polymer was purified by the following steps to obtain pure PP-g-PMMA. 1 g polymer and 50 mL xylene were mixed in a 500 mL flask and the flask was heated to 90-100° C. in an oil bath until the reaction mixture was completely dissolved and a clear solution was formed. The polymer solution was then cooled to room temperature, and 50 mL acetone was added to induce precipitation of a white solid. The white solid was obtained by air-suction assisted filtration. The white solid was washed with 50 mL acetone three times. After drying in a vacuum oven at 80° C., pure PP-g-PMMA with a grafting yield of about 3.8% was prepared.

### COMPARATIVE EXAMPLE 3

0.5 g benzoyl peroxide (BPO) and 6 g methyl methacrylate (MMA) were mixed and stirred in a beaker at room temperature until the benzoyl peroxide was completely dissolved. The resulting solution was slowly dropped into 53.5 g polypropylene chips and the blend was well stirred. The polypropylene chips were then subjected to a twin-screw extrusion at ca. 210° C. to induce melt reaction to obtain a mixture polymer containing polypropylene-g-polymethyl methacrylate (PP-g-PMMA) as in Comparative Example 2.

The mixture was then purified by the following steps. 1 g mixture polymer and 50 mL xylene were mixed and stirred in a 500 mL round bottom flask and heated to 90-100° C. until the mixture was completely dissolved to form a clear solution. The solution was then cooled to room temperature, and 50 mL acetone was added into the solution to induce precipitation of a white solid. The white solid was separated by air-suction assisted filtration, and followed by washing with 50 mL acetone three times. After drying in a vacuum oven at 80° C., a pure white solid of PP-g-PMMA with a grafting yield of about 0.2% was obtained.

### EXAMPLE 1

0.3 g benzoyl peroxide (BPO) and 6 g methyl methacrylate (MMA) were mixed and stirred in a beaker at room temperature until the benzoyl peroxide was completely dissolved. The resulting solution was then slowly dropped into a mixture of 25 g polypropylene and 5 g PP-g-PMMA chips, and the mixture was stirred. The wet chip blend was subsequently charged into a twin-screw reactor to induce melt reaction to obtain a mixture polymer containing polypropylene-g-polymethyl methacrylate (PP-g-PMMA).

The polymer mixture was then purified by the following steps. 1 g mixture and 50 mL xylene were mixed and heated in a 500 mL flask to 90-100° C. until the mixture was completely dissolved to form a clear solution. The solution was then cooled to room temperature, and 50 mL acetone was added into the solution to induce precipitation of a white solid. The white solid was then separated by air-suction assisted filtration, and followed by washing with 50 mL acetone three times. After drying in a vacuum oven at 80° C., a pure white solid of PP-g-PMMA was obtained. The composition of PP-g-PMMA solid was confirmed by FTIR analysis. The grafting yield of the sample thereof was calculated by comparison of the peak areas of the aldehyde group (C═O) (1736 cm⁻¹) and the methyl group (CH₃) (2722 cm⁻¹) in the FTIR spectra. As a result, a polypropylene-g-polymethyl methacrylate (PP-g-PMMA) polymer with a grafting yield of about 6.26% was prepared.

### EXAMPLE 2

0.3 g benzoyl peroxide (BPO), 5 g methyl methacrylate (MMA) and 1 g styrene were mixed and stirred in a beaker at room temperature until the benzoyl peroxide was completely dissolved. The resulting solution was then slowly dropped into a mixture of 25 g polypropylene and 5 g PP-g-PMMA chips, and the mixture was stirred. The wet chip blend was subsequently charged into a twin-screw reactor to induce melt reaction to obtain a mixture polymer containing polypropylene-g-styrene-polymethyl methacrylate (PP-g-styrene-PMMA).

### EXAMPLE 3

0.3 g benzoyl peroxide (BPO) and 6 g acrylic acid (AA) were mixed and stirred in a beaker at room temperature until the benzoyl peroxide was completely dissolved. The resulting solution was then slowly dropped into a mixture of 25 g polypropylene and 5 g PP-g-PMMA chips, and the mixture was stirred. The wet chip blend was subsequently charged into a twin-screw reactor to induce melt reaction to obtain a mixture polymer containing polypropylene-g-polymethyl methacrylate (PP-g-PAA).

TABLE 1

| No. | PP | Monomer | Compatibilizer | Grafting rate (%)^{a} |
|---|---|---|---|---|
| Comparative | powder | MMA | N | 4.45 |
| Example 1 | | | | |
| Comparative | powder | MMA | N | 3.80 |
| Example 2 | | | | |
| Comparative | chip | MMA | N | 0.25 |
| Example 3 | | | | |
| Example 1 | chip | MMA | Y | 6.26 |

^{a}The grafting rate was determined by IR.

While the invention has been described by way of examples and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A polypropylene derivative comprising a reactive monomer grafted on polypropylene, with a grafting yield exceeding 5%.

2. The polypropylene derivative as claimed in claim 1, wherein the reactive monomer comprises unsaturated ethylene monomers.

3. The polypropylene derivative as claimed in claim 1, wherein the reactive monomer comprises methyl(meth)acrylate, benzyl(meth)acrylate, ethyl(meth)acrylate, 2-hydroxyethyl(meth)acrylate, hydroxylpropyl(meth)acrylate, isobutyl(meth)acrylate, methyl acrylate, benzyl acrylate, ethyl acrylate, 2-hydroxyethyl acrylate, hydroxylpropyl acrylate, isobutyl acrylate, styrene, vinyltoluene, methylstyrene, 2,4-dimethylstyrene, vinyl acetate, vinyl propionate, Vinyl pivalate or combinations thereof.

4. The polypropylene derivative as claimed in claim 1, wherein the polypropylene derivative has a grafting yield exceeding 6%.

5. The polypropylene derivative as claimed in claim 1, wherein the polypropylene derivative has a melt index of 9-35.

6. The polypropylene derivative as claimed in claim 1, wherein the polypropylene derivative is a spinning-level polymer.

7. A method for preparing a polypropylene derivative comprising mixing a reactive monomer, polypropylene and a compatibilizer to prepare a polypropylene derivative grafted with the reactive monomer, with a grafting yield exceeding 5%.

8. The method for preparing a polypropylene derivative as claimed in claim 7, wherein the polypropylene derivative is prepared in a reaction tank, twin-screw mixer, single-screw mixer, single-screw extruder, twin-screw extruder, Banbury mixer or continuous mixer.

9. The method for preparing a polypropylene derivative as claimed in claim 7, wherein the polypropylene and the reactive monomer are pre-mixed.

10. The method for preparing a polypropylene derivative as claimed in claim 7, wherein the polypropylene comprises grains, powders or a combination thereof.

11. The method for preparing a polypropylene derivative as claimed in claim 7, wherein the reactive monomer comprises unsaturated ethylene monomers.

12. The method for preparing a polypropylene derivative as claimed in claim 7, wherein the reactive monomer comprises methyl(meth)acrylate, benzyl(meth)acrylate, ethyl(meth)acrylate, 2-hydroxyethyl(meth)acrylate, hydroxylpropyl(meth)acrylate, isobutyl(meth)acrylate, methyl acrylate, benzyl acrylate, ethyl acrylate, 2-hydroxyethyl acrylate, hydroxylpropyl acrylate, isobutyl acrylate, styrene, vinyltoluene, methylstyrene, 2,4-dimethylstyrene, vinyl acetate, vinyl propionate, Vinyl pivalate or combinations thereof.

13. The method for preparing a polypropylene derivative as claimed in claim 7, wherein the compatibilizer comprises surfactants.

14. The method for preparing a polypropylene derivative as claimed in claim 13, wherein the surfactant comprises polypropylene-containing surfactants.

15. The method for preparing a polypropylene derivative as claimed in claim 14, wherein the surfactant comprises grafted copolymers or block copolymers of the polyethylene and the reactive monomer.

16. The method for preparing a polypropylene derivative as claimed in claim 7, wherein the reactive monomer has an amount of 5-25 wt % (based on the total weight of the reactant).

17. The method for preparing a polypropylene derivative as claimed in claim 7, wherein the reactive monomer has an amount of 10-15 wt % (based on the total weight of the reactant).

18. The method for preparing a polypropylene derivative as claimed in claim 7, wherein the compatibilizer has an amount of 20-50 wt % (based on the total weight of the reactant).

19. The method for preparing a polypropylene derivative as claimed in claim 7, wherein the compatibilizer has an amount of 30-40 wt % (based on the total weight of the reactant).

20. The method for preparing a polypropylene derivative as claimed in claim 7, further comprising mixing an initiator.

21. The method for preparing a polypropylene derivative as claimed in claim 20, wherein the initiator comprises peroxide.

22. The method for preparing a polypropylene derivative as claimed in claim 21, wherein the initiator comprises benzoyl peroxide (BPO).

23. The method for preparing a polypropylene derivative as claimed in claim 7, wherein the polypropylene derivative has a melt index of 9-35.

24. The method for preparing a polypropylene derivative as claimed in claim 7, wherein the polypropylene derivative is a spinning-level polymer.
